(19) United States
(12) Patent Application Publication
(10) Pub. No.: US 2008/0078276 A1
(43) Pub. Date: Apr. 3, 2008

(54) PANEL SAW MACHINE FOR PANELS MADE OF WOOD OR SIMILAR MATERIALS

(75) Inventor: Piergiorgio Benuzzi, Bologna (IT)

Correspondence Address: PEARNE & GORDON LLP, 1801 EAST 9TH STREET, SUITE 1200, CLEVELAND, OH, 44114-3108, US

(73) Assignee: GIBEN INTERNATIONAL S.P.A., Pianoro (Bologna) (IT)

(21) Appl. No.: 11/862,527

(22) Filed: Sep. 27, 2007

(30) Foreign Application Priority Data
Sep. 29, 2006 (IT) BO2006A000673

(51) Int. Cl. B26D 7/06

(52) U.S. Cl. 83/109

(57) ABSTRACT

A panel saw machine (2) for panels (1) made of wood or similar materials comprises: a horizontal table (3) for supporting the panels (1); means (4) for advancing the panels (1) along a feed line (A) and mobile in a direction parallel to and along the horizontal table (3); a straight cutting unit (5) transversal to the feed line (A) and comprising a base (10), presser means (6) for holding down the panels (1), and a first saw blade (7) mobile in both directions and protruding lengthways from a slot made in the horizontal table (3) in such a such a way as to cut the panels (1) along a line (T) transversal to the feed line (A); the cutting unit (5) comprises a carriage (8) which rotatably mounts the first blade (7) and which is rotatably connected to guide means (9) associated with the base (10); first means (11) for driving the carriage (8), designed to allow the carriage (8) to move in both directions along the transversal line (T); second means (12) for driving the first blade (7), positioned on the base (10) and kinematically connected, through first drive transmission means (13), to the first blade (7) in such a way as to enable the latter to rotate continuously.

### BACKGROUND OF THE INVENTION

This invention relates to a panel saw machine for panels made of wood or similar materials.

At present, panel saw machines essentially comprise:

a main frame comprising a first horizontal table;

means for advancing the panels along a defined feed line and usually consisting of a crossbar mobile in parallel along said first horizontal table and equipped with clamps used for gripping the panel or panels to be sawn;

a straight cutting unit transversal to the feed line and comprising a beam that mounts one or two hold-down bars for pressing down on the panels, and a carriage, positioned near the beam and equipped with at least one mobile circular blade designed to cut the panels along a line transversal to the beam and usually passing between the hold-down bars;

a second table, positioned in front of the cutting unit, downstream of the cutting unit relative to the panel feed line on the first horizontal table, for supporting the panels and/or the respective panel lengths obtained by cutting.

Over time, these panel saw machines have been continually improved in all the parts described above in order to increase productivity, enhance panel cutting quality and make machine operation safer.

Thus, if on the one hand targets of high quality have been achieved, on the other, machine purchase and maintenance costs have risen proportionately. In practice, increased costs have restricted the range of potential machine buyers to companies with high productivity requirements that can quickly amortize the high initial cost of the machines, while individual craftsmen, one-person concerns and medium- to low-productivity companies cannot in most cases afford to buy machines of this kind.

For example, the above mentioned blade unit or carriage, which this specification refers to in particular, usually consists of a mobile unit or carriage that mounts the main blade and, normally, a smaller blade known as “scoring blade”. The two blades protrude from a slot made in the first horizontal table.

The carriage is usually driven by a motor which enables it to move along the cutting axis, transversal to the feed line, and mounts at least one other motor to drive the main and scoring blades.

In addition to that, the carriage must be equipped with a motor-driven system for adjusting the height of the blades relative to the first horizontal table in accordance with the thickness and number of panels to be cut.

This structure, in its entirety, makes the carriage extremely heavy which means, in turn, that it requires a suitably sized mounting base made from metal fabrications with high-strength guides and a plurality of machined features to allow the passage of cables and conduits for power and air supply lines (to release the blade and extract sawdust) along the whole cutting front.

As a result, this structure is extremely expensive, takes a very long time to assemble and, especially for the electrical and air systems, requires frequent maintenance which must be carried out by specialized personnel and which increases the overall cost of running the machine.

### SUMMARY OF THE INVENTION

The aim of this invention is therefore to overcome the above mentioned disadvantages by providing a panel saw machine for panels made of wood or similar materials having an extremely compact, lightweight, reliable and inexpensive blade unit with a mounting and drive structure that is simple and practical so as to reduce the assembly and maintenance costs of the blade unit.

According to the invention, this aim is achieved by a panel saw machine, especially a panel saw machine for panels made of wood or similar materials, comprising the technical characteristics described in one or more of the appended claims.

### BRIEF DESCRIPTION OF THE DRAWINGS

The technical features of the invention, with reference to the above aims, are clearly described in the claims below and its advantages are more apparent from the detailed description which follows, with reference to the accompanying drawings which illustrate a preferred embodiment of the invention provided merely by way of example without restricting the scope of the inventive concept, and in which:

FIG. 1 is a schematic top plan view of a panel saw machine according to the invention, for panels made of wood or similar materials;

FIG. 2 illustrates the panel saw machine of FIG. 1 in a schematic front view from P, with some parts cut away in order to better illustrate others;

FIG. 3 is a scaled-up front view of a detail P1 from FIG. 2, showing the blade carriage;

FIG. 4 is a partial cutaway of the panel saw machine according to the invention, viewed from P2 in FIG. 2;

FIG. 5 is a detail from FIG. 2, showing a blade carriage in a different operating configuration.

### DESCRIPTION OF THE PREFERRED EMBODIMENTS

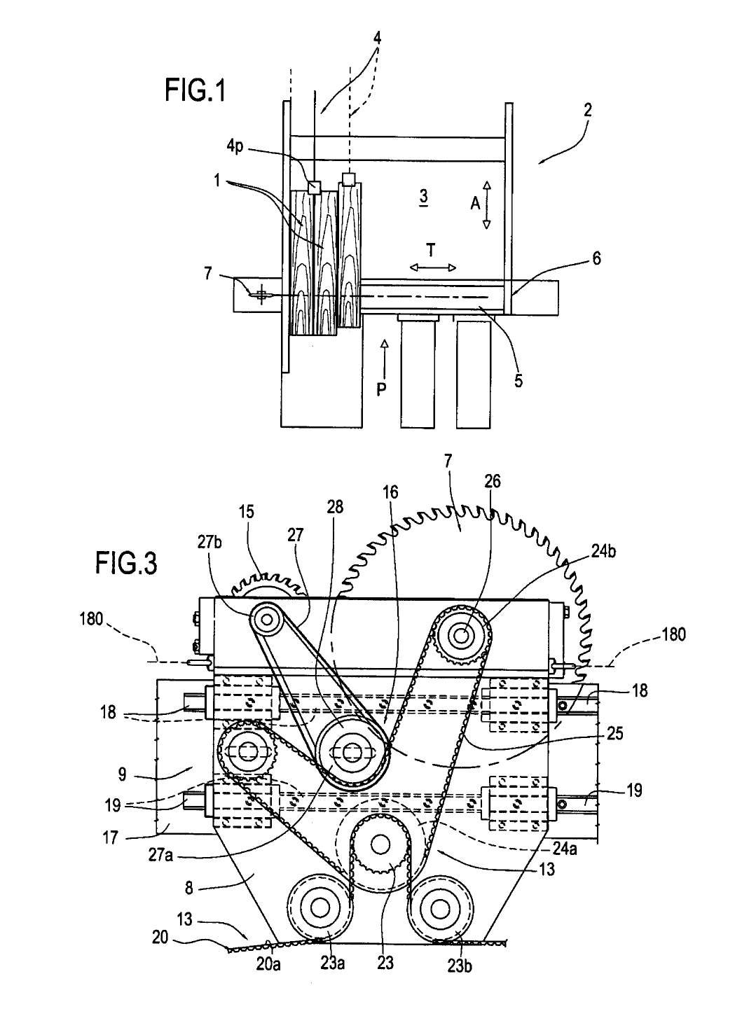

With reference to the accompanying drawings, in particular FIG. 1, the panel saw machine according to the invention is used for cutting panels 1 made of wood or similar materials.

This panel saw machine, labeled 2 in its entirety, essentially comprises:

a horizontal table 3 for supporting the panels 1;

means 4 for advancing the panels 1 along a feed line A and mobile in a direction parallel to and along the horizontal table 3 (illustrated schematically with gripper clamps 4p, being of customary type and not strictly relevant to this invention);

a straight cutting unit 5 transversal to the feed line A and comprising at least one base 10, presser means 6 for holding down the panels 1, and a first saw blade 7 positioned close to the presser means 6, mobile in both directions and protruding lengthways from a slot made in the horizontal table 3 in such a way as to cut the panels 1 along a line T transversal to the feed line A.

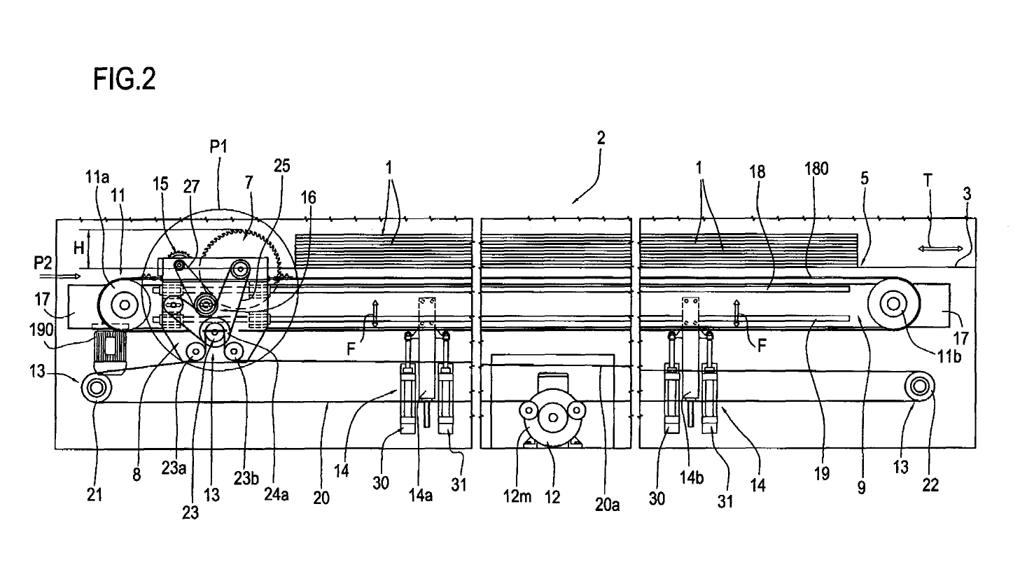

As illustrated in FIGS. 2 to 4, the cutting unit 5 comprises:

a carriage 8 which rotatably mounts the first blade 7 and which is rotatably connected to adjustable horizontal guide means 9 associated with the mounting base 10 defined by a vertical wall 10;

first means 11 for driving the carriage 8, designed to allow the carriage 8 to move in both directions along the transversal line T;

second means 12 for driving the first blade 7, mounted under the horizontal table 3, associated with the mounting wall 10 and kinematically connected, through first drive transmission means 13, to the first blade 7 in such a way as to enable the first blade 7 to rotate continuously independently of its position along the transversal cutting line T.

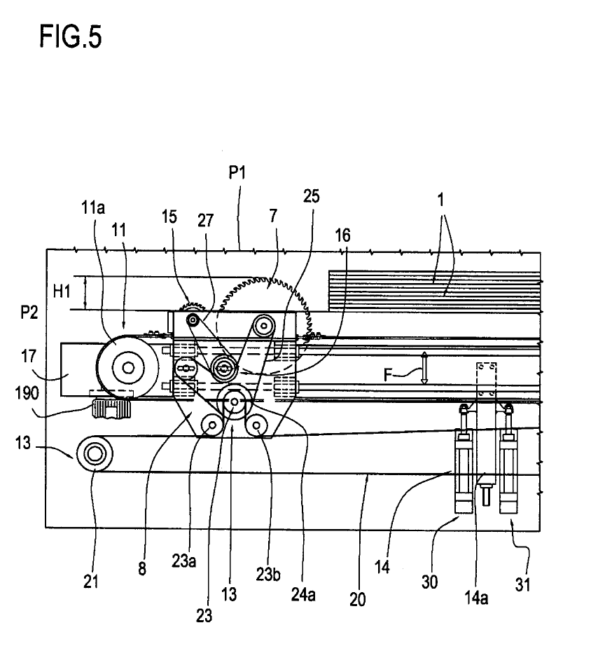

In addition, (see FIGS. 2, 4 and 5), the cutting unit 5 further comprises means 14 for supporting and adjusting the height H-H1 of the blade 7 relative to the horizontal table 3, said means being positioned on the mounting wall 10 and acting on the adjustable guide means 9 in such a way as to vertically adjust the guide means 9 themselves and the carriage 8 in both directions (see arrows F in FIGS. 2 and 5).

Again with reference to FIGS. 2 and 3, the carriage 8 may have rotatably mounted on it a second blade 15, or scoring blade, positioned alongside the first, main blade 7, and connected to the second drive means 12 through second drive transmission means 16 in turn connected to the above mentioned first drive transmission means 13 and mounted on the carriage 8.

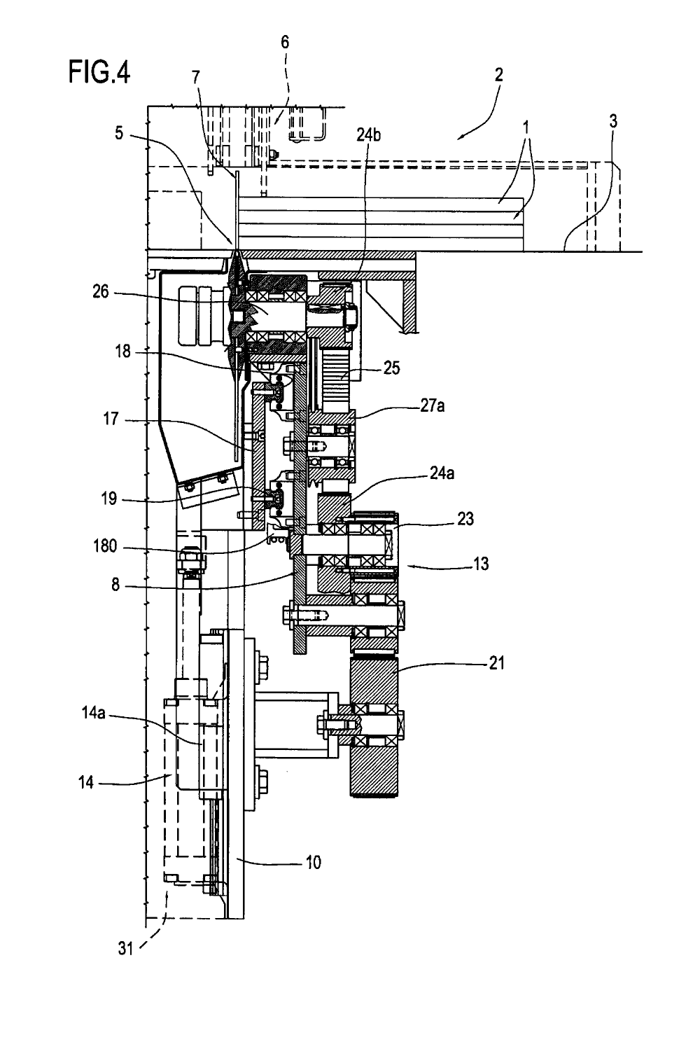

Looking more closely at the technical details (see FIGS. 2 and 4) the aforementioned guide means 9 comprise a horizontal plate 17 provided with a pair of horizontal guides 18 and 19 to which the carriage 8 is slidably constrained.

The first drive means 11 comprise a pair of first pulleys 11a and 11b, mounted at the respective ends of the cutting unit 5 and rotatably constrained to the horizontal plate 17.

Trained around the pair of first pulleys 11a and 11b there is a first endless belt 180 for driving the carriage 8 and associated, at its free ends, with the carriage 8 itself.

Further, the pulley labeled 11a is connected to a respective first drive unit 190 (for example, a customary geared motor) for driving the pulleys 11a and 11b and, hence, the carriage 8 by pushing and/or pulling.

The aforementioned second means 12 for driving the two blades 7 and 15 comprise a second drive unit 12m mounted close to the mounting wall 10 (positioned on a tread surface under the table 3) and used to drive a second endless belt or cable 20 (preferably of steel) trained around at least one second pair of pulleys 21 and 22 rotatably associated with the ends of the wall 10 in such a way that the sections of the second belt 20 are positioned at least along the full extent of the cutting unit 5.

It should be underlined that the belts or cables described in this text and illustrated in the accompanying drawings may be of any kind, that is to say, toothed belts, flat belts, Vee belts or cables made of any material, without thereby restricting the scope of the inventive concept.

The upper section 20a of the second belt 20 is engaged with the first drive transmission means 13 positioned on the carriage 8 in order to drive the first blade 7 independently of the movement and position of the carriage 8 along the cutting unit 5.

More specifically, the first drive transmission means 13 (see FIG. 3) comprise at least one third pulley 23 which is rotatably associated with the carriage 8 and engaged by the upper section 20a of the second belt 20.

The third pulley 23 is coaxially keyed to one of a fourth pair of pulleys 24a and 24b with a third endless belt 25 trained around them; the other fourth pulley 24b is coaxially keyed to a shaft 26 that mounts the first blade 7 and rotationally drives the latter by transmitting the motion derived from the third pulley 23.

The above mentioned second transmission means 16 may comprise a fourth endless belt 27 trained around a fifth pair of pulleys 27a and 27b, one of which is coaxially keyed to the second blade 15. The fifth pulley 27b is rotatably keyed to the carriage 8 in a position such that it engages, by means of a sixth pulley 28 coaxial with and connected to the fifth pulley 27b, a section of the third belt 25 that drives the first blade 7 in such a way as to simultaneously also rotate the second blade 15.

The aforementioned means 14 for adjusting the height H of the first blade 7 may comprise at least one pair of vertical guides 14a and 14b that run along the wall 10 and are associated at their upper ends with the plate 17 that mounts the carriage 8 and the guides 18 and 19.

Close to each guide 14a and 14b there is at least one actuating element 30, 31, acting on the plate 17 and integral with the wall 10 in such a way as to enable the plate 17 to be adjusted vertically in both directions (as clearly illustrated also in FIG. 5).

In particular, but without limiting the scope of the invention, each guide 14a and 14b may be equipped with a pair of actuating elements 30, 31 positioned on opposite sides of, and associated with, the guide 14a and 14b, and acting with its stem on the plate 17.

Obviously, there may be more than two guides 14a, 14b, depending on the size and extent of the cutting unit 5, without thereby limiting the scope of the inventive concept.

In view of the possibility of adjusting the carriage 8 in height (obviously within a certain operating range depending on the diameter of the blade and on the number and thickness of the panels), the invention contemplates the provision of two wheels 23a, 23b on opposite sides of the third pulley 23, for transmitting motion to the upper section 20a of the second belt 20 in such a way as to define the path of the belt 20 and keep the latter tensioned and in contact with the third pulley 23.

A panel saw machine made as described above thus achieves the above mentioned aims thanks to a structure for driving and adjusting the blade carriage made extremely simple and light.

This is made possible by the fact that the mobile parts of the blade unit consist of a simple carriage with the two blades on it and a plurality of belts and pulleys mounted on a plate equipped with slide guides and on which there is only the system for driving the carriage drive pulleys.

The rotational drive of the blades, on the other hand, is indirect, independent of the carriage and accomplished by a belt and by the blade transmission elements: that means the moving parts are lighter in weight and eliminates the need for electrical and air connections that move along with the carriage, with obvious advantages in terms of machine reliability and safety.

Moreover, the height adjustment of the blade is accomplished by guides located on the vertical wall and connected directly to the mounting plate which is thus able to slide in both directions to enable the blades to be correctly positioned in height.

This type of architecture, therefore, optimizes the cutting area, making it inexpensive and free of moving cables and conduits for the electrical and air systems and thus reducing maintenance requirements and times.

The invention described above is susceptible of industrial application and may be modified and adapted in several ways without thereby departing from the scope of the inventive concept. Moreover, all the details of the invention may be substituted by technically equivalent elements.

1. A panel saw machine for panels (1) made of wood or similar materials, the panel saw machine (2) comprising at least:
a horizontal table (3) for supporting the panels (1);
means (4) for advancing the panels (1) along a feed line (A), said means (4) being mobile in a direction parallel to and along the horizontal table (3);
a straight cutting unit (5) transversal to the feed line (A) and comprising at least one base (10), presser means (6) for holding down the panels (1), and a first saw blade (7) positioned close to the presser means (6), mobile in both directions and protruding lengthways from a slot made in the horizontal table (3) in such a such a way as to cut the panels (1) along a line (T) transversal to the feed line (A), wherein the cutting unit (5) of the panel saw machine (2) comprises:
a carriage (8) which rotatably mounts the first blade (7) and which is rotatably connected to horizontal guide means (9) associated with the base (10);
first means (11) for driving the carriage (8), designed to allow the carriage (8) to move in both directions along the transversal line (T);
second means (12) for indirectly driving the first blade (7), mounted on the base (10) and kinematically connected, through first drive transmission means (13), to the first blade (7) in such a way as to enable the latter to rotate.

2. The machine according to claim 1, further comprising means (14) for supporting and adjusting the height (H) of the blade (7) relative to the horizontal table (3), said means being positioned on the base (10) and acting on the horizontal guide means (9) in such a way as to vertically adjust the guide means (9) themselves and the carriage (8) in both directions.

3. The machine according to claim 1, wherein the carriage (8) has rotatably mounted on it a second blade (15), or scoring blade, positioned alongside the first, main blade (7), and connected to the second drive means (12) through second drive transmission means (16) in turn connected to the first drive transmission means (13) and mounted on the carriage (8).

4. The machine according to claim 1, wherein the guide means (9) comprise a horizontal plate (17) provided with a pair of horizontal guides (18, 19) to which the carriage (8) is slidably constrained.

5. The machine according to claim 1, wherein the first drive means comprise a pair of first pulleys (11a, 11b), mounted at the respective ends of the cutting unit (5) and rotatably constrained to a horizontal plate (17) forming part of the guide means (9); trained around the first pulleys (11 a, 11 b) there being a first endless belt (180) for driving the carriage (8) and associated, at its free ends, with the carriage (8) itself; the pulley (11a) being connected to a respective first drive unit (190).

6. The machine according to claim 1, wherein the second means (12) for driving the first blade (7) comprise a second drive unit (12m) associated with the base (10) and used to drive a second endless belt or cable (20) trained around at least one second pair of pulleys (21, 22) rotatably associated with the ends of the base (10) in such a way that the sections of the second belt (20) are positioned at least along the full extent of the cutting unit (5); the upper section (20a) of the second belt (20) being engaged with the first drive transmission means (13) positioned on the carriage (8) in order to drive the first blade (7) independently of the movement and position of the carriage (8) along the cutting unit (5).

7. The machine according to claim 6, wherein the first drive transmission means (13) comprise at least one third pulley (23) which is rotatably associated with the carriage (8) and engaged by the upper section (20a) of the second belt (20); the third pulley (23) being coaxially keyed to one of a fourth pair of pulleys (24a, 24b) with a third endless belt (25) trained around them; the other fourth pulley (24a, 24b) being coaxially keyed to a shaft (26) that mounts the first blade (7) and rotationally drives the latter.

8. The machine according to claim 3, wherein the second drive transmission means (16) comprise a fourth endless belt (27) trained around a fifth pair of pulleys (27a, 27b), one of which is coaxially keyed to the second blade (15) and the other rotatably keyed to the carriage (8) in a position such that it engages, by means of a sixth pulley (28) coaxial with and connected to the fifth pulley (27a, 27b), a section of the third belt (25) that drives the first blade (7) in such a way as to simultaneously also rotate the second blade (15).

9. The machine according to claim 2, wherein the means (14) for adjusting the height of the first blade (7) comprise at least one pair of vertical guides (14a, 14b) that run along the base (10) and are associated at their upper ends with a plate (17) that mounts the carriage (8) and the guides (9); close to each guide (14a, 14b) there being at least one actuating element (30, 31) acting on the plate (17) and integral with the base (10) in such a way as to enable the plate (17) to be adjusted vertically in both directions.

10. The machine according to claim 9, wherein each guide (14a, 14b) is equipped with two actuating elements (30, 31) positioned on opposite sides of, and associated with, the guide (14a, 14b), and acting with their stems on the plate (17).

11. The machine according to claim 7, comprising, on opposite sides of the third pulley (23), two wheels (23a, 23b) for transmitting motion to the upper section (20a) of the second belt (20) in such a way as to define the path of the belt (20) and keep the latter tensioned and in contact with the third pulley (23).

12. The machine according to claim 6, wherein the second drive transmission means (16) comprise a fourth endless belt (27) trained around a fifth pair of pulleys (27a, 27b), one of which is coaxially keyed to the second blade (15) and the other rotatably keyed to the carriage (8) in a position such that it engages, by means of a sixth pulley (28) coaxial with and connected to the fifth pulley (27a, 27b), a section of the third belt (25) that drives the first blade (7) in such a way as to simultaneously also rotate the second blade (15).

13. The machine according to claim 7, wherein the second drive transmission means (16) comprise a fourth endless belt (27) trained around a fifth pair of pulleys (27a, 27b), one of which is coaxially keyed to the second blade (15) and the other rotatably keyed to the carriage (8) in a position such that it engages, by means of a sixth pulley (28) coaxial with and connected to the fifth pulley (27a, 27b), a section of the third belt (25) that drives the first blade (7) in such a way as to simultaneously also rotate the second blade (15).
